(19) United States
(12) Patent Application Publication
(10) Pub. No.: US 2014/0166404 A1
(43) Pub. Date: Jun. 19, 2014

(54) PALLET AND PRODUCT PROTECTOR

(71) Applicant: Geoffrey Richard Sharp, Visalia, CA (US)

(72) Inventor: Geoffrey Richard Sharp, Visalia, CA (US)

(21) Appl. No.: 13/720,393

(22) Filed: Dec. 19, 2012

(51) Int. Cl. B66F 9/075

(52) U.S. Cl. CPC B66F 9/07504
USPC 187/222

(57) ABSTRACT

A pallet and product protector for a lift truck. The pallet and product protector can include an impact portion and a mounting portion coupled to the impact portion. The impact portion can include a central impact plate having a pair of ends and a side impact plate disposed at each of the pair of ends of the central impact plate. The side impact plate can be coupled to the central impact plate in slidable relation thereto.

### BACKGROUND

Lift trucks, also known as forklifts, are commonly used in warehousing, storage, and similar applications to transport packaged materials between locations, and to raise and stack packaged materials for storage. To facilitate transporting and lifting the materials, such materials are typically packaged and disposed on top of a pallet. Commonly used pallets are constructed from wood and have a bottom deck and a top deck coupled to a plurality of parallel stringers disposed therebetween, with openings provided between the stringers. A pallet can have a pair of stringers disposed at the edges of the pallet, and a third stringer disposed substantially halfway between the pair of stringers. Forklifts have a pair of movable or forks, that are inserted into the openings. Once the forks are disposed within the openings, the forklift can lift and transport the pallet.

The forks of a lift truck are part of a carriage assembly, which is in turn coupled to a mast of the lift truck. The carriage assembly moves vertically along the mast, allowing the pallet and the load thereon to be moved to a desired height. Additionally, the carriage assemblies of certain lift trucks are configured to allow lateral movement of the forks, so as to allow the forks to be adapted to pallets of varying width. Additionally, some carriage assemblies may be configured for movement in the longitudinal direction, allowing the forks to be positioned forwardly from the body of the lift truck.

For example, certain lift trucks, such as reach trucks, are adapted for use and maneuverability in tight spaces. To that end, the reach trucks have compact bodies; however, to provide balance during load lifting, the wheelbase of the reach truck is longer than the body of the truck. This is accomplished by positioning the front load wheels forwardly of the mast of the truck, at the distal end of wheel extensions extending forward from the body of the truck. The carriage assembly and forks are coupled to the mast via an outrigging mechanism. This allows the carriage assembly and forks to be positioned proximate the body and between the wheel extensions when maneuvering, or to be extended forward of the wheel extensions when picking up a pallet.

During operations, lift trucks can impact the pallet with the vertical portions of the forks. The force of these impacts is applied to the top deck of the pallet and to the goods disposed on top of the pallet and that may be overhanging the pallet. Consequently, individuals and businesses suffer significant losses due to product damage, pallet damage, as well as due to the labor involved in replacing pallets and products and restacking products on undamaged pallets.

### SUMMARY

According to at least one exemplary embodiment, a pallet and product protector for a lift truck is disclosed. The pallet and product protector can include an impact portion and a mounting portion coupled to the impact portion. The impact portion can include a central impact plate having a pair of ends and a side impact plate disposed at each of the pair of ends of the central impact plate. The side impact plate can be coupled to the central impact plate in slidable relation thereto. In some exemplary embodiments, the pallet and product protector can further include at least one resilient member engaged with at least one side impact plate so as to exert a force thereon. In some exemplary embodiments, the pallet and product protector can further include a channel defined in the central impact plate, wherein a portion of each side impact plate is slidably received within the channel. The resilient means may be disposed within the channel. Furthermore, in some exemplary embodiments, the impact portion may be coupled to the mounting portion so as to allow the impact portion to pivot, translate, tilt, or combinations thereof, with respect to the mounting portion.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a front isometric view of an exemplary embodiment of a pallet and product protector.

FIG. 2 is a front elevational view of an exemplary embodiment of a pallet and product protector.

FIG. 3 is a rear elevational view of an exemplary embodiment of a pallet and product protector.

FIG. 4 is a top plan view of an exemplary embodiment of a pallet and product protector.

FIG. 5 is a bottom plan view of an exemplary embodiment of a pallet and product protector.

FIG. 6 is a side elevational view of an exemplary embodiment of a pallet and product protector.

FIG. 7a is a front exploded view of a mounting plate of an exemplary embodiment of a pallet and product protector.

FIG. 7b is a side exploded view of a mounting plate of an exemplary embodiment of a pallet and product protector.

FIG. 8a is a front exploded view of an impact portion of an exemplary embodiment of a pallet and product protector.

FIG. 8b is a side view of a central impact plate of an exemplary embodiment of a pallet and product protector.

FIG. 9 is a front exploded view of a resilient member of an exemplary embodiment of a pallet and product protector.

FIG. 10 shows an exemplary embodiment of a pallet and product protector mounted on a lift truck.

FIG. 11a is a front view of an exemplary embodiment of a pallet and product protector mounted on a lift truck.

FIG. 11b shows a side impact plate of an exemplary embodiment of a pallet and product protector being compressed.

FIG. 11c shows the impact portion of an exemplary embodiment of a pallet and product protector being tilted.

FIG. 11d shows the impact portion of an exemplary embodiment of a pallet and product protector being pivoted.

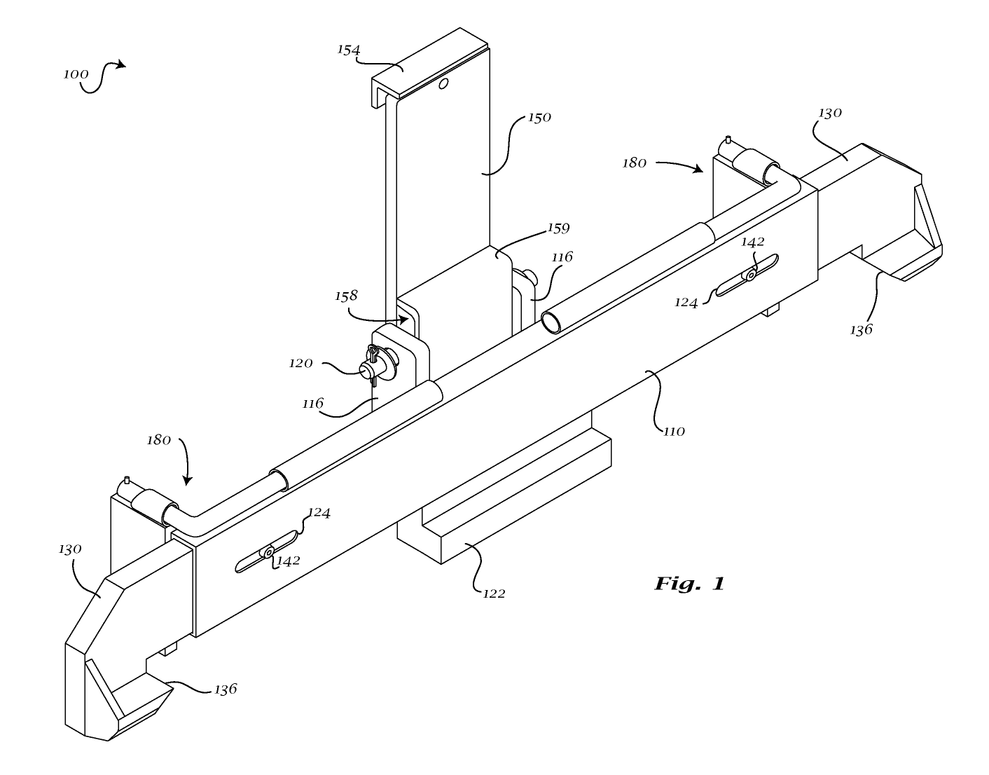

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

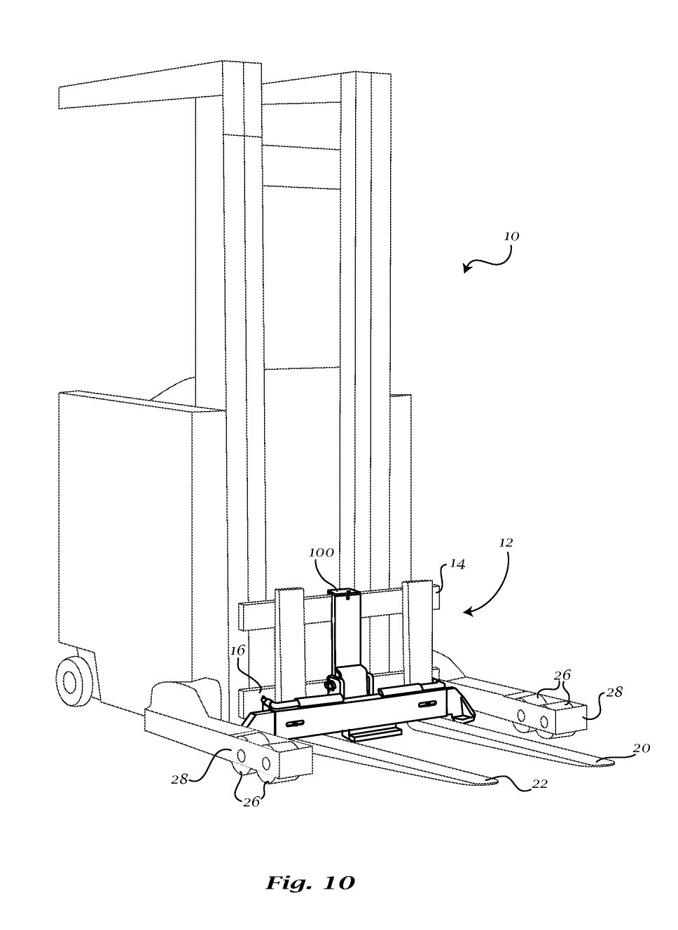

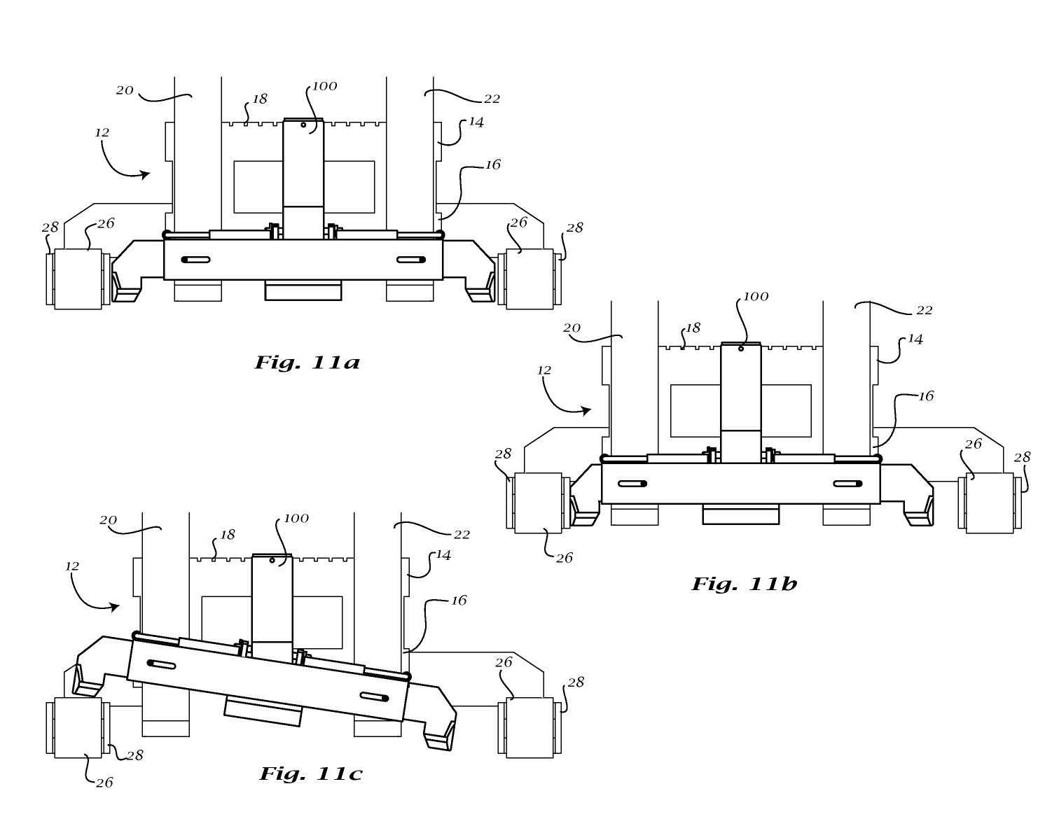

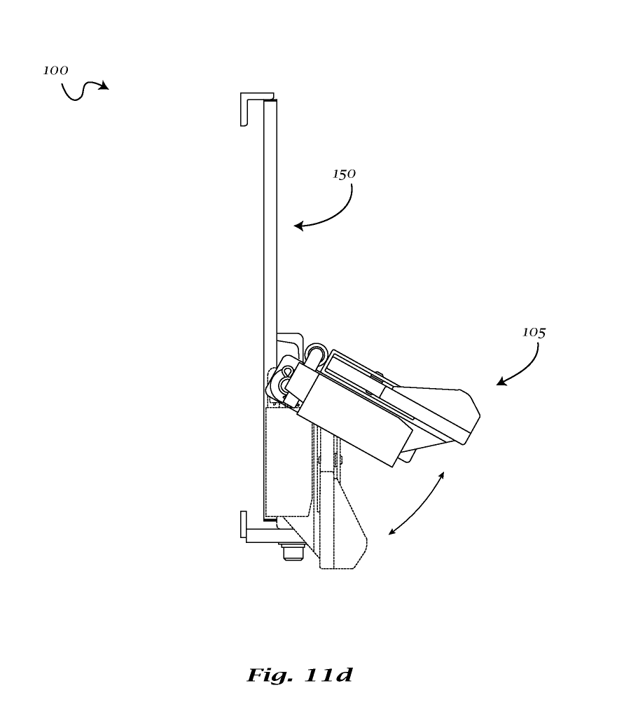

FIG. 10 and FIGS. 11a-11c show an exemplary embodiment of a pallet and product protector 100 attached to a lift truck 10 having a pair of L-shaped forks 20, 22. Typically, forks 20, 22 can be a part of a carriage assembly 12. The carriage assembly 12 can include an upper carriage bar 14 and a lower carriage bar 16. Additionally, one or both of carriage bars 14, 16 may include a plurality of regularly spaced index notches 18 provided along the carriage bar, so as to facilitate positioning of the forks or other attachments at desired locations on the carriage bar. Carriage assembly 12 can be vertically adjustable, while forks 20, 22 can be laterally adjustable with respect to each other and to carriage assembly 12. Carriage assembly 12 can also be longitudinally adjustable with respect to the body of the lift truck 10. Additionally, lift truck 10 can have an extended wheelbase, with wheels 26 positioned at the distal ends of extensions 28 extending forwardly from the body of lift truck 10.

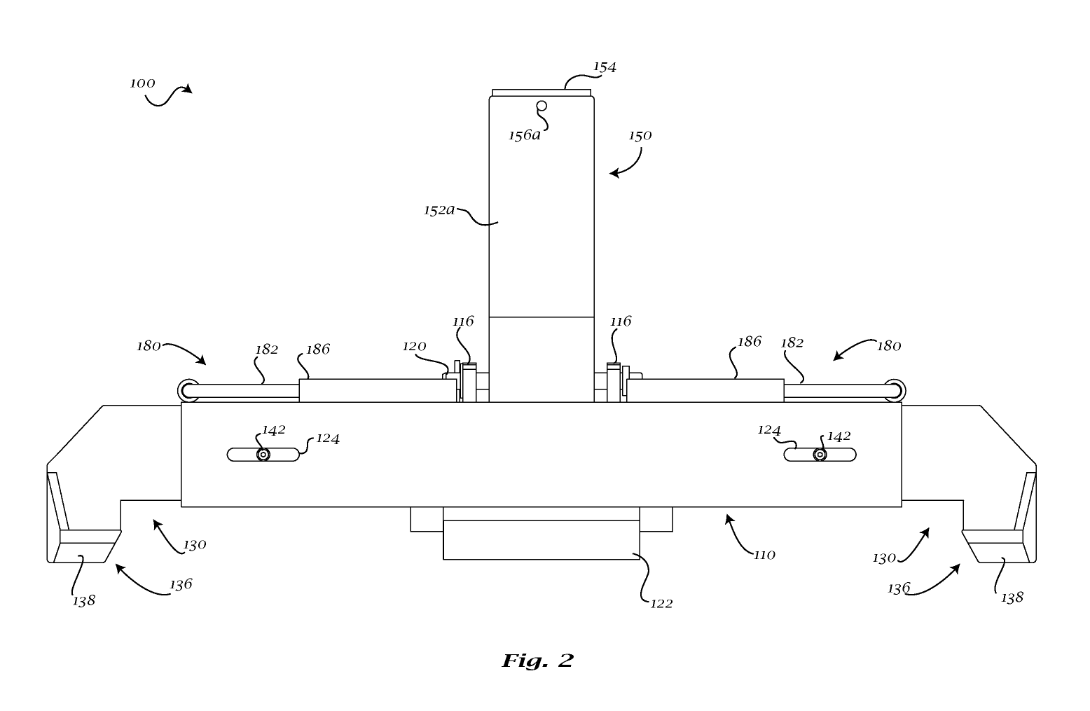

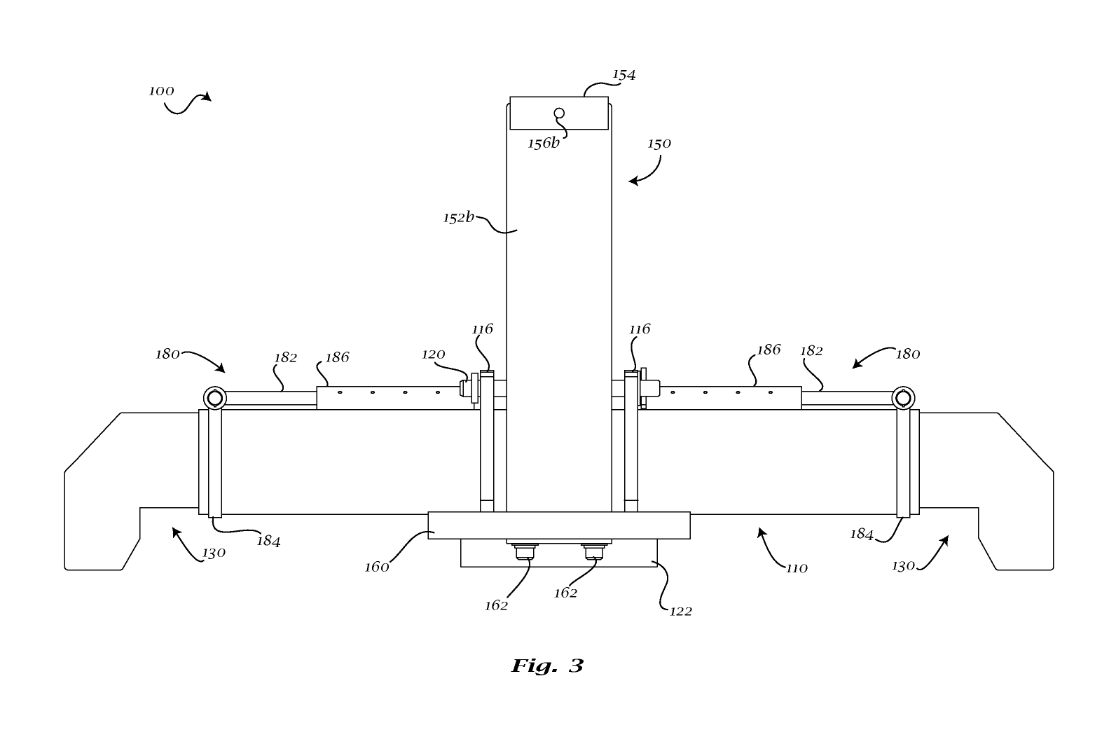

Generally referring to FIGS. 2-9, an exemplary embodiment of a pallet and product protector 100 can include an impact portion 105, which can include a central impact plate 110 and a pair of side impact plates 130. Central impact plate 110 may enclose a channel 112, the channel 112 being sized and shaped to slidably receive the side impact plates 130 therein. Protector 100 can further include a mounting plate 150, the mounting plate being adapted to couple to a carriage assembly of a lift truck.

Mounting plate 150 may have any desired shape and dimensions that enable protector 100 to function as described herein. In the illustrated exemplary embodiment, mounting plate 150 can have a substantially rectangular, vertically elongated shape. Extending rearwardly from mounting plate 150 may be at least one coupling member 154. The coupling member may be sized and shaped to couple mounting plate 150 to the carriage assembly of a lift truck 10. For example, coupling member 154 may be substantially L-shaped and sized to receive a portion of an upper carriage bar 14 of a lift truck between the coupling member and the rear face 152b of mounting plate 150.

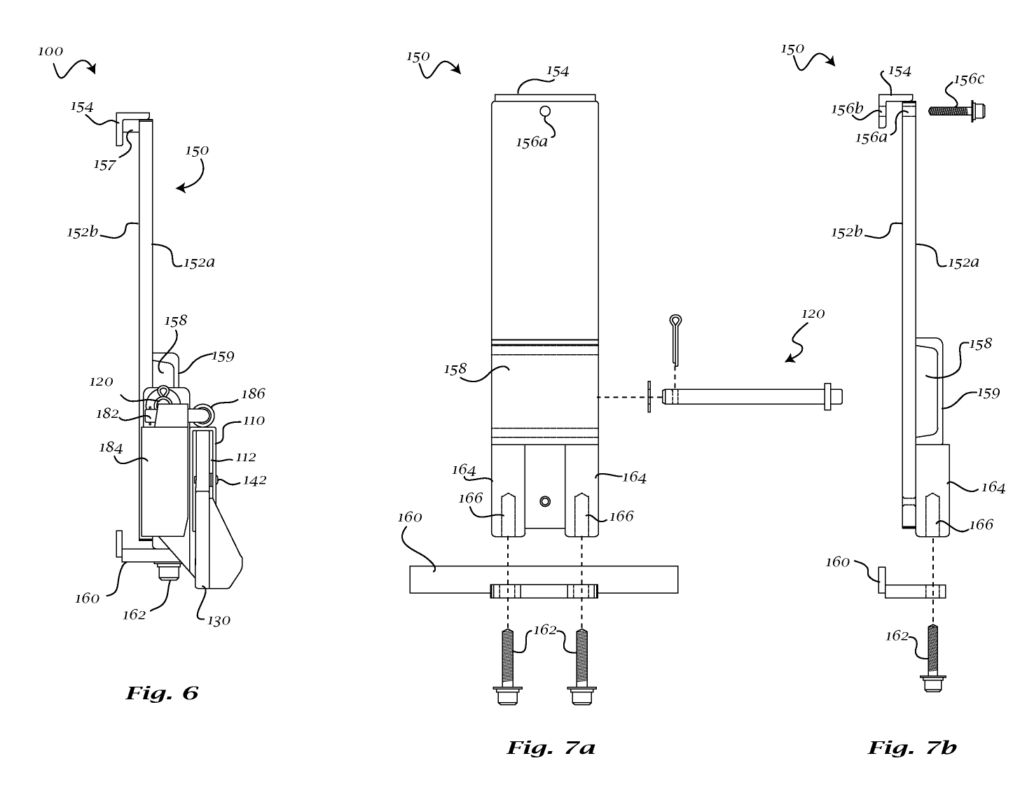

As shown in FIGS. 7a-7b, in some exemplary embodiments, a pair of apertures 156a, 156b may be defined in mounting plate 150 and the vertical portion of coupling member 154 and disposed coaxially with respect to each other. An elongated member 156c, which may be threaded, for example a dowel, pin, bolt, or the like, may be received through apertures 156a, 156b. The elongated member 156c may be sized and shaped to be received within an index notch 18 of a carriage bar 14, so as to facilitate the ease positioning of protector 100 at the midpoint of the carriage bar or at any other desired index notch. In other exemplary embodiments, as shown in FIG. 6, a centering nub 157 may extend from the rear face 152 of mounting plate 150. Centering nub 157 may be provided in lieu of apertures 156a, 156b and elongated member 156c, may be disposed at substantially the same location, and may be sized and shaped to be received within an index notch 18 of a carriage bar 14.

Defined in a portion of mounting plate 150 may be a slot 158. Slot 158 may be vertically elongated and may have a depth sufficient to receive a coupling member of central impact plate 110, as described further below. The width of slot 158 may be any width that enables protector 100 to function as described herein. In the illustrated embodiment, the width of slot 158 may be substantially similar to the width of mounting plate 150. Slot 158 may be disposed substantially proximate the central portion of mounting plate 150, however, the positioning of slot 158 may be adjusted as desired during manufacture based on any pertinent considerations. In some exemplary embodiments, slot 158 may be defined between the front face 152a of mounting plate 150 and a U-shaped member 159 coupled thereto.

Removably coupled to the lower portion of mounting plate 150 may be a clamping member 160. Clamping member 160 may be sized and shaped to engage lower carriage bar 16, so as to facilitate securing protector 100 to carriage assembly 12. For example, clamping member 160 may be substantially L-shaped and sized to receive a portion of a lower carriage bar 16 of a lift truck between the clamping member and the rear face 152b of mounting plate 150. Coupling between mounting plate 150 and clamping member 160 may be facilitated by at least one fastener 162, for example a screw, bolt, or any other fastener that allows the vertical position of clamping member 160 to be adjusted as desired. In some exemplary embodiments, as shown in FIGS. 7a-7b, each fastener 162 may be received within a bore 166 defined in a block 164, the block 164 being coupled to and extending from the front face 152a of mounting plate 150. The vertical adjustability of clamping member 160 in relation to mounting plate 150 can facilitate applying a desired pressure to carriage bars 14, 16 by coupling member 154 and clamping member 160, respectively, thereby facilitating a secure mounting of protector 100 on carriage assembly 12. Additionally, as diverse models of forklifts may have varying distances between upper and lower carriage bars 14, 16, the vertical adjustability of clamping member 160 can allow protector 100 to be coupled to a variety of forklift models.

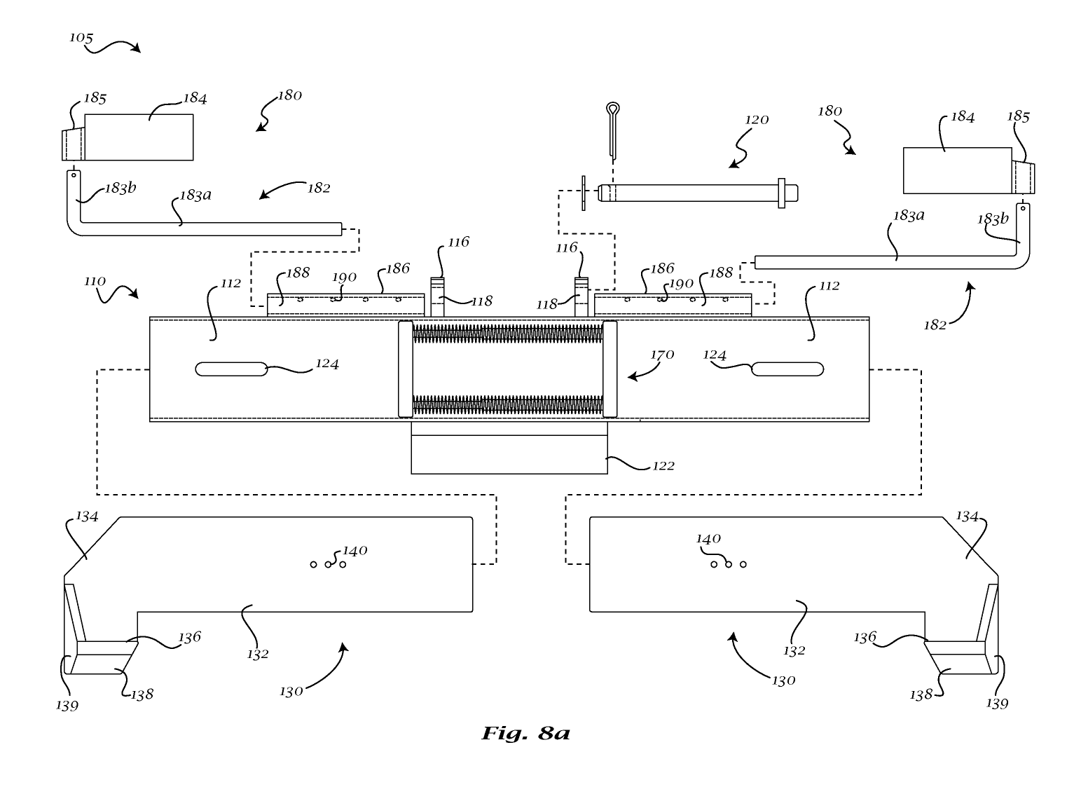

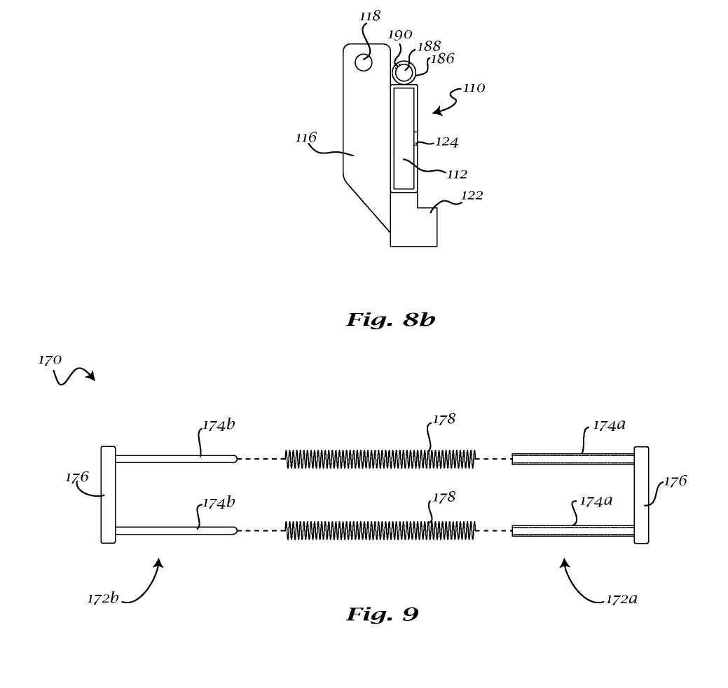

Turning to FIGS. 8a-8b, central impact plate 110 may have any desired shape that enables protector 100 to function as described herein. In the illustrated exemplary embodiment, central impact plate 110 may be shaped as a horizontally elongated rectangular prism. A channel 112, open on both ends, may extend through central impact plate 110, substantially parallel to the longitudinal axis thereof. Extending rearwardly from the rear face 114 of mounting plate 110 may be a pair of spacer members 116. A portion of each spacer member 116 may extend above central impact plate 110. Extending through each spacer member 116 may be a bore 118, which may be oriented substantially parallel to the longitudinal axis of mounting plate 110.

Spacer members 116 may be positioned such that mounting plate 150 may be received between spacer members 116 and such that mounting plate 150 is substantially centered along the longitudinal axis of mounting plate 110. Mounting plate 150 may further be disposed such that slot 158 of the mounting plate is aligned with bores 118 of the spacer members. A coupling member 120 may then be received through bores 118 and slot 158 to couple central impact plate 110 to mounting plate 150. Coupling member 120 may be any coupling member that allows protector 100 to function as described herein. For example, coupling member 120 may be a clevis pin in combination with a cotter pin, a bolt in combination with a nut, or any other member capable of passing through bores 118 and slot 158, and having structures to facilitate maintaining the coupling member within bores 118 and slot 158.

Coupling member 120 may move without substantial impediment within slot 158. Coupling member 120 may rotate about its longitudinal axis within slot 158, may translate along the vertical length of slot 158, may tilt within slot 158, or any combination of these movements. This can allow central impact plate 110 to pivot with respect to mounting plate 150, substantially about the longitudinal axis of coupling member 120, as shown in FIG. 11d. Furthermore, this can allow central impact plate 110 to be vertically movable with respect to mounting plate 150, and further allowing central impact plate 110 to tilt with respect to mounting plate 150, as shown in FIG. 11c.

In some exemplary embodiments, slot 158 may be provided on central impact plate 110, for example defined between the rear face of central impact plate 110 and a U-shaped member 159 coupled thereto. In such embodiments, spacer members 116 may be provided on mounting plate 150, and the coupling between plates 110, 150 may be accomplished substantially as described above. It should be appreciated that any coupling between plates 110 and 150 that allows protector 100 to function as described herein may be contemplated and provided without departing from the scope of the embodiments described herein.

Extending forwardly and substantially horizontally from the lower portion of the front face of central impact plate 110, and oriented substantially centrally with respect to central impact plate 110, may be a central impact extension 122. Central impact extension 122 may impact the center stringer of a pallet, and may serve to provide additional clearance between the pallet and central impact plate 110, so as to reduce the likelihood of contact between the lift truck and the materials that are overhanging the pallet. In some exemplary embodiments, an impact absorbing member, for example a rubber covering or the like, may be provided on the surface of central impact extension 122.

Each side impact plate 130 may be sized and shaped such that a portion thereof can be slidably received within channel 112 of central impact plate 110. Side impact plates 130 may have any desired shape that enables protector 100 to function as described herein. In the illustrated exemplary embodiment, each side impact plate 130 may have a elongated portion 132 that is slidably received within channel 112. A distal end 134 of each side impact plate 130 may include a side impact extension 136. A portion of the side impact extension 136 can be disposed below the lower edge of side impact plate 130. The side impact extension can further extend substantially transversely with respect to the longitudinal axis of side impact plate 130. Side impact extension 136 may impact a side stringer of a pallet, and may serve to provide additional clearance between the pallet and impact plates 110, 130.

The lower surface 138 of side impact extension 136 may have a substantially rounded shape, a wedge shape, a trapezoidal prism shape, or any other shape that enables protector 100 to function as described herein. In some exemplary embodiments, the faces of lower surface 138 of side impact extension 136 may be oriented at oblique angles to each other. Additionally, a portion of the outer side face 139 of side impact extension 136 may be oriented at an oblique angle to the front face of side impact plate 130. Such a configuration of the lower surfaces and the outer side face can reduce the likelihood of side impact extension 136 being caught within gaps or on edges during operation. For example, such a configuration can allow side impact extension 136 to slide over the extensions 28, wheels 26, and wheel housings of the lift truck 10, or any other object, without being caught thereon. In some exemplary embodiments, an impact absorbing member, for example a rubber covering or the like, may be provided on the surfaces of central impact extension 136.

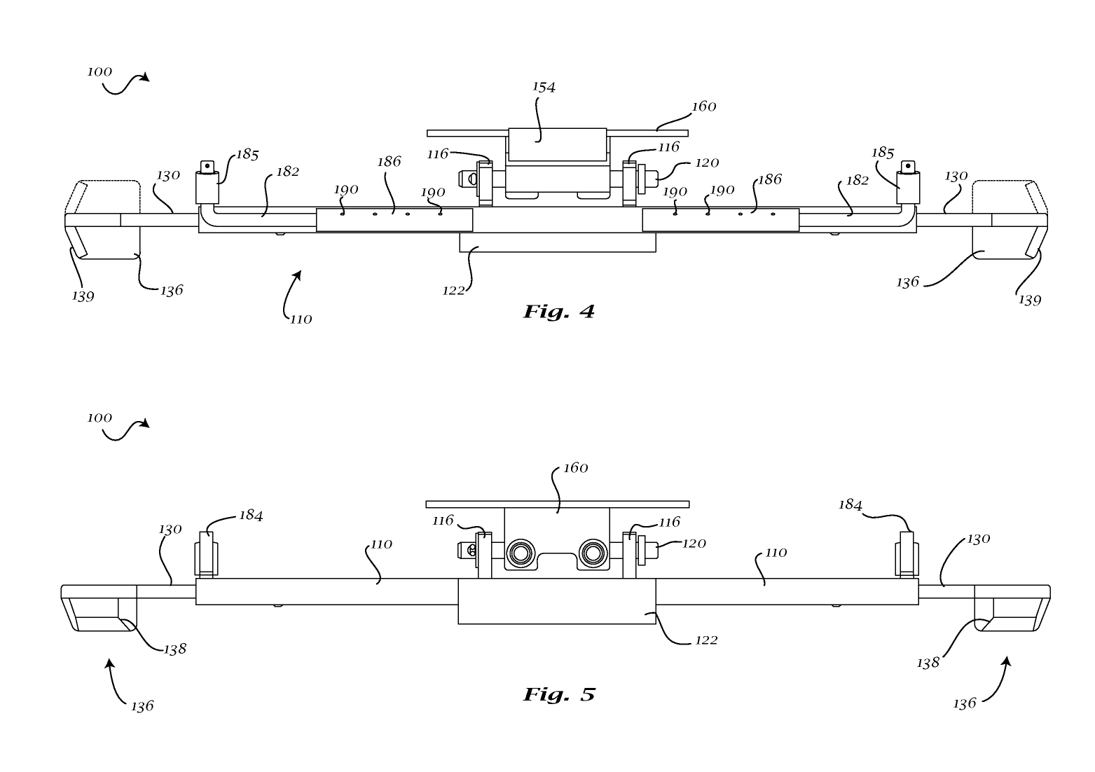

Side impact plates 130 may be interchangeable. That is, either side impact plate 130 may be inserted into either end of channel 112. This can allow the user to orient side impact plates 130 such that the side impact extension 136 extends forwardly or rearwardly with respect to protector 100, as shown in FIG. 4.

Defined in both the front and rear face of elongated portion 132 of side impact plate 130 may be at least one aperture 140. Aperture 140 may removably receive a stopper 142 therein. Stopper 142 may include a stem sized to be received within aperture 140 and a head sized to protrude beyond the corresponding face of elongated portion 132. Stopper 142 may include any known structure that can allow stopper 142 to be retained within aperture 140 and removed therefrom as desired, for example threads, movable tabs, and so forth. When side impact plate 130 is disposed within channel 112, the head of stopper 142 can be received within a slit 124 defined in a face of central impact portion 110. Contact between stopper 142 and the edges of slit 124 can define the limits for the lateral movement of side impact plate 130 within channel 112. In some exemplary embodiments, a plurality of apertures 140 may be provided, thereby allowing the user to select a desired limit for the extension of side impact plate 130 in relation to channel 112. Furthermore, it should be appreciated that, while the illustrated embodiment shows slit 124 defined in the front face of central impact plate 110 and apertures 140 defined in the front face of side impact plate 130, other exemplary embodiments can include slits 124 and apertures 130 defined in the rear or bottom faces of their corresponding impact portions, or in any other location that enables protector 100 to function as described herein.

Disposed within channel 112 be a resilient member 170. Resilient member 170 may be disposed between side impact plates 130, and may be configured to exert a laterally outward force on side impact plates 130. Resilient member 170 may further be configured to exert a force so as to maintain side impact plates 130 at the outer extension limit thereof, which may be defined by stopper 142.

Resilient member 170 may have any structure that allows protector 100 to function as described herein. In the illustrated exemplary embodiment, as shown in FIG. 9, resilient member 170 may include a first and second pushing member 172a, 172b. Each pushing member 172a/172b can include a head 176 for engaging a proximal end 133 of elongated portion 132. Each pushing member 172a/172b can further include a pair of stems 174a/174b couplet to head 176. Each stem 174a of first pushing member 172a may be hollow, with the diameter of the hollow being sized to slidably receive a stem 174b of pushing member 172b therein. Coil springs 178 may be disposed between the pair of pushing members 172a/172 and surrounding the stems 174a/174b. The edges of spring 178 can then engage heads 178 of the pushing members 172a/172b so as to exert a force thereon, and the heads 176 can exert the force on side impact plates 130.

Protector 100 can further include a pair of bracing assemblies 180. Each bracing assembly 180 can include a stem 182 and a plate 184. Stem 182 may have a pair of legs 183a, 183b oriented at a substantially right angle to each other. Legs 183a, 183b may have diverse lengths. The first leg 183a of stem 182 may be slidably and rotatably received within the bore of a housing 185 coupled to plate 184. Plate portion 184 may be oriented orthogonally to the first portion 183a and the second portion 183b of stem 182.

A pair of barrel members 186 may be coupled to the upper face of central impact portion 110 and disposed outwardly from spacer members 116. Each barrel member 186 can include a bore 188 defined therein, bore 188 being sized and shaped to slidably and rotatably receive a second portion 183b of stem 182 therein. A plurality of apertures 190 may extend through each barrel member 186. Threaded fasteners may be received through apertures 190, so as to contact the portion of stem 182 disposed therein, thereby securing stem 182 within bore 188. The position and orientation of bracing assemblies 180 can be adjusted as desired so as to position bracing assemblies 180 proximate the outer edges of the vertical portions of forks 20, 22 of lift truck 10, as shown in FIG. 11a. Bracing assemblies 180 can serve to maintain impact portion 105 aligned with the forks 20, 22 of the lift truck, as shown in FIGS. 11a-11b, including when impact portion 105 is tilted with respect to mounting plate 150, as shown in FIG. 11c. Furthermore, the adjustability of bracing assemblies 180 can allow protector 100 to be used with lift trucks having varying spans between the forks, without resulting in impact portion 105 becoming laterally misaligned.

In operation, pallet and product protector 100 can be attached to the carriage assembly 12 of a lift truck 10, substantially as described above and as shown in FIGS. 10 and 11a. The operator can then proceed with loading the pallet onto the forklift, by inserting the horizontal portions of forks 20, 22 into the spaces provided between the stringers of a pallet. As the forks are moved into position underneath the pallet, front impact plate 110 can come into contact with a portion of the pallet, for example the upper deck. Additionally, impact extensions 138 and/or 122 can come into contact with the side stringers and the middle stringer of the pallet, respectively. The impact force can thus be distributed along a greater contact area than if the pallet and product were to be impacted solely by the vertical portions of forks 20, 22, and damage to the pallet and the product may be prevented.

As pallet and product protector 100 is disposed forward of forks 20, 22, and substantially at the height of the pallet when it is proximate to the forklift, any materials that are loaded on the pallet are not likely to come into contact with, or impact, forks 20, 22 or pallet and product protector 100, thereby reducing the likelihood of damage to the materials. Additionally, extensions 138 and/or 122 may provide additional clearance between the pallet and the forklift, further reducing the likelihood of damage to the materials.

In operation, as shown in FIG. 11b, if the operator of the lift truck side shifts forks 20, 22 into the extensions 28, or into any other object, the slidable impact plate 130 on the particular side can be pushed into channel 112 of central impact plate 110, exerting force on resilient member 170. The side impact plate on the opposite end can be maintained at its outermost limit of movement by the contact between its stopper 142 and the edges of the corresponding slit 124. Consequently, resilient member 170 can be compressed, and, when the forks are returned to a central position, resilient member 170 can exert a force on the side impact plate 130 so as to return it to its original position.

Furthermore, in operation, a portion of a pallet, the products thereon, the wheels 26 or extensions 28 of the lift truck, or any other object may interfere with a portion of impact portion 105 of protector 100. In such an event, impact portion 105 can tilt with respect to mounting plate 150, as shown in FIG. 11c, slide upwardly with respect to mounting plate 150, and/or pivot about the coupling between impact portion 105 and mounting plate 150, as shown in FIG. 11d.

The embodiments of the pallet and product protector 100 described herein can thus minimize damage to pallets and products resulting from impact with the forks of a lift truck. The pallet and product protector 100 can further be adaptable for use with reach truck type lift trucks, by allowing the width of the pallet and product protector to adjust based on the available clearance. Furthermore, contact between the impact plates and other objects is not likely to interfere with the mounting of the protector or the operation of the lift truck; rather, the impact plates are adapted to tilt, pivot, translate vertically, and otherwise move so as not to interfere with portions of the lift truck, the product or pallet, or other objects.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A pallet and product protector for a lift truck, comprising:
an impact portion, the impact portion including a central impact plate having a pair of ends and a side impact plate disposed at each of the pair of ends of the central impact plate, the side impact plate being coupled to the central impact plate in slidable relation thereto; and
a mounting portion coupled to the impact portion.

2. The pallet and product protector of claim 1, further comprising at least one resilient member engaged with at least one side impact plate so as to exert a force thereon.

3. The pallet and product protector of claim 1, further comprising:
a channel defined in the central impact plate;
wherein a portion of each side impact plate is slidably received within the channel.

4. The pallet and product protector of claim 3, further comprising at least one resilient member disposed within the channel and engaged with at least one side impact plate so as to exert a force thereon.

5. The pallet and product protector of claim 1, wherein the distance between the side impact plates can be varied.

6. The pallet and product protector of claim 1, wherein the impact portion is pivotably coupled to the mounting portion.

7. The pallet and product protector of claim 1, wherein the impact portion is coupled to the mounting portion so as to allow the impact portion to pivot, translate, tilt, or combinations thereof, with respect to the mounting portion.

8. A pallet and product protector for a lift truck, comprising:
a central impact plate having a pair of opposing ends and a channel extending therebetween;
a pair of side impact plates, each side impact plate disposed at an opposing end of the central impact plate, a portion of each side impact plate being slidably received within the channel; and
a mounting plate coupled to and disposed rearwardly of the central impact plate.

9. The pallet and product protector of claim 8, further comprising:
at least one resilient member engaged with at least one side impact plate so as to exert a force thereon.

10. The pallet and product protector of claim 9, wherein the at least one resilient member is disposed within the channel and between the pair of side impact plates.

11. The pallet and product protector of claim 8, wherein the central impact plate is pivotably coupled to the mounting plate.

12. The pallet and product protector of claim 8 wherein the central impact plate is slidably coupled to the mounting plate.

13. The pallet and product protector of claim 8, wherein:
the mounting plate includes a vertically elongated slot for receiving a coupling member therethrough; and
the central impact plate includes a pair of spacer members, each spacer member having a bore for receiving the coupling member therethrough.

14. The pallet and product protector of claim 8, wherein the central impact plate is coupled to the mounting plate so as to allow the central impact plate to pivot, translate, tilt, or combinations thereof, with respect to the mounting plate.

15. The pallet and product protector of claim 8, further comprising a central impact extension extending from the central impact plate.

16. The pallet and product protector of claim 8, further comprising a side impact extension extending from each side impact plate.

17. The pallet and product protector of claim 8, further comprising a pair of bracing members coupled thereto.

18. A pallet and product protector for a lift truck, comprising:
means for mounting the pallet and product protector on the lift truck;
a central impact means for coming into contact with a central portion pallet;
a first side impact means for coming into contact with a first side portion of the pallet; and
a second side impact means for coming into contact with a second side portion of the pallet;
wherein the first side impact means and second side impact means are slidably coupled to the central impact means.

19. The pallet and product protector of claim 18, further comprising:
resilient means for exerting a force on at least one of the first side impact means and the second slide impact means.

20. The pallet and product protector of claim 17, further comprising means for pivoting, translating, tilting, or combinations thereof, the central impact means, first side impact means, and second side impact means in relation to the mounting means.
